(19) United States
(12) Patent Application Publication
(10) Pub. No.: US 2024/0154095 A1
(43) Pub. Date: May 9, 2024

(54) COLUMNAR SILICON ANODE HAVING A CARBONACEOUS NETWORK AND METHODS OF FORMING THE SAME

(71) Applicant: GM GLOBAL TECHNOLOGY OPERATIONS LLC, Detroit, MI (US)

(72) Inventors: Zhe LI, Shanghai (CN); Xingcheng XIAO, Troy, MI (US); Qili SU, Shanghai (CN); Yong LU, Shanghai (CN)

(73) Assignee: GM GLOBAL TECHNOLOGY OPERATIONS LLC, Detroit, MI (US)

(21) Appl. No.: 18/127,444

(22) Filed: Mar. 28, 2023

(30) Foreign Application Priority Data
Nov. 9, 2022 (CN) 202211399235.3

(51) Int. Cl. H01M 4/36; H01M 4/04; H01M 4/38; H01M 4/583; H01M 10/0525

(52) U.S. Cl. CPC H01M 4/364; H01M 4/0404; H01M 4/0471; H01M 4/386; H01M 4/583; H01M 10/0525; H01M 2004/027

(57) ABSTRACT

An electrochemical cell includes a first electrode that includes a first current collector and a first electroactive material layer disposed on or near the first current collector, a second electrode that includes a second current collector and a second electroactive material layer disposed on or near the second current collector, and a separating layer disposed between the first electroactive material layer and the second electroactive material layer. The second electroactive material layer includes a plurality of hierarchical silicon columns, each of the hierarchical silicon columns has a longest dimension perpendicular to a major axis of the second current collector. The second electroactive material layer also includes a carbonaceous network that at least partially fills interstices defined between hierarchical silicon columns of the plurality of hierarchical silicon columns. The carbonaceous network includes linked carbon atoms that define a plurality of pores.

### CROSS-REFERENCE TO RELATED APPLICATIONS

This application claims the benefit and priority of Chinese Application No. 202211399235.3, filed Nov. 9, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte layer (or solid-state separator), the solid-state electrolyte layer (or solid-state separator) may physically separate the electrodes so that a distinct separator is not required.

Many different materials may be used to create components for a lithium-ion battery. The negative electrode typically includes a lithium insertion material or an alloy host material. Certain anode materials have particular advantages.

While graphite having a theoretical specific capacity of 372 mAh g⁻¹ is most widely used in lithium-ion batteries, anode materials with high specific capacity, for example high specific capacities ranging about 900 mAh g⁻¹ to about 4,200 mAh g⁻¹, are of growing interest. For example, silicon has the highest known theoretical capacity for lithium (e.g., about 4,200 mAh·g⁻¹), making it an appealing material for rechargeable lithium-ion batteries. Such materials, however, often have low intrinsic electrical conductivity (e.g., about 10⁻⁵ S/cm) at room temperature (e.g., about 25° C.), which is much lower than the intrinsic electrical conductivity of carbon (e.g., greater than or equal to about 10 S/cm to less than or equal to about 10⁴ S/cm at the same temperature. The low intrinsic electrical conductivity of silicon may can cause deterioration of rate performance for the lithium-ion battery, hindering practical high-power applications. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to electrodes including hierarchical silicon columns and a carbonaceous network that at least partially fills spaces between the hierarchical silicon columns, and to methods of forming and using the same.

In various aspects, the present disclosure provides an electrode for an electrochemical cell that cycles lithium ions. The electrode includes an electroactive material layer. The electroactive material layer includes a plurality of hierarchical silicon columns having interstices defined between hierarchical silicon columns of the plurality of hierarchical silicon columns, and a carbonaceous network that at least partially fills the interstices. The carbonaceous network includes linked carbon atoms that define a plurality of pores.

In one aspect, the electroactive material layer may have a total porosity greater than 0 vol. % to less than or equal to about 40 vol. %, and the carbonaceous network may fill greater than or equal to about 60 vol. % to less than or equal to about 100 vol. % of the total porosity.

In one aspect, the electroactive material layer may further include a carbonaceous electroactive material.

In one aspect, the electroactive material layer may include greater than or equal to about 40 wt. % to less than or equal to about 99.99 wt. % of the hierarchical silicon columns, and greater than 0.01 wt. % to less than or equal to about 60 wt. % of the carbonaceous electroactive material.

In one aspect, the carbonaceous network may have a porosity greater than 0 vol. % to less than or equal to about 80 vol. %.

In one aspect, the carbonaceous network may further include greater than 0 wt. % to less than or equal to about 50 wt. % of a heteroatom.

In one aspect, the heteroatom may be selected from the group consisting of: nitrogen, boron, oxygen, sulfur, phosphorus, silver, zinc, magnesium, iron, and combinations thereof.

In one aspect, the electrode may further include a current collector disposed on or adjacent to the electroactive material layer, where a longest dimension of each hierarchical silicon column may be perpendicular to a major axis of the current collector.

In one aspect, a surface of the current collector that faces the electroactive material layer may have a roughen surface having a Rz greater than 0 μm to less than or equal to about 12 μm.

In one aspect, the hierarchical silicon columns may have an areal capacity greater than or equal to about 0.5 mAh/cm 2 to less than or equal to about 20 mAh/cm², and the carbonaceous network may have an electrical conductivity greater than or equal to about 10⁻³ S/cm to less than or equal to about 10⁴ S/Cm at 22° C. and a BET surface area greater than or equal to about 5 m²/g to less than or equal to about 4,000 m²/g.

In various aspects, the present disclosure provides an electrochemical cell that cycles lithium ions. The electrochemical cell may include a first electrode that includes a first current collector and a first electroactive material layer disposed on or near the first current collector, a second electrode that includes a second current collector and a second electroactive material layer disposed on or near the second current collector, and a separating layer disposed between the first electroactive material layer and the second electroactive material layer. The second electroactive material layer may include a plurality of hierarchical silicon columns, each of the hierarchical silicon columns having a longest dimension perpendicular to a major axis of the second current collector. The second electroactive material layer may also include a carbonaceous network that at least partially fills interstices defined between hierarchical silicon columns of the plurality of hierarchical silicon columns. The carbonaceous network may include linked carbon atoms that define a plurality of pores.

In one aspect, the separating layer may be a solid-state electrolyte.

In one aspect, the separating layer may include a liquid electrolyte.

In one aspect, the second electroactive material layer may further include a carbonaceous electroactive material. The second electroactive material layer may include greater than or equal to about 40 wt. % to less than or equal to about 99.99 wt. % of the hierarchical silicon columns, greater than 0.01 wt. % to less than or equal to about 60 wt. % of the carbonaceous electroactive material, and greater than or equal to about 0.01 wt. % to less than or equal to about 60 wt. % of the carbonaceous network.

In one aspect, the second electroactive material layer may have a total porosity greater than 0 vol. % to less than or equal to about 40 vol. %, and the carbonaceous network may fill greater than or equal to about 60 vol. % to less than or equal to about 100 vol. % of the total porosity.

In one aspect, the carbonaceous network may further include greater than 0 wt. % to less than or equal to about 50 wt. % of a heteroatom. The heteroatom may be selected from the group consisting of: nitrogen, boron, oxygen, sulfur, phosphorus, silver, zinc, magnesium, iron, and combinations thereof.

In one aspect, a surface of the second current collector that faces the second electroactive material layer may have a roughen surface having a Rz greater than 0 μm to less than or equal to about 12 μm.

In various aspects, the present disclosure provides a method for forming an electrode. The method may include contacting a columnar silicon anode film and a fluidic carbon precursor so the fluidic carbon precursor impregnates the columnar silicon anode film and forms a precursor assembly. The columnar silicon anode film may be defined by a plurality of hierarchical silicon columns defining interstices therebetween. The method may also include heating the precursor assembly to a temperature greater than or equal to about 300° C. to less than or equal to about 1,000° C. to carbonize the fluidic carbon precursor so as to form a carbonaceous network that at least partially fills the interstices between the hierarchical silicon columns.

In at least one aspect, the fluidic carbon precursor may be an ionic liquid that includes a cation and an anion. The cation may be selected from the group consisting of: Li(triglyme) ([Li(G₃)]±), Li(tetraglyme) ([Li(G₄)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyle-3-butylimidazolium ([DMBim]⁺), 1-alkyl-3-methylimidazolium ([Cnmim]⁺), 1-ally-3-methylimidazolium ([Amim]⁺), 1,3-diallylimidazolium ([Daim]⁺), 1-ally-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr 12]⁺), 1-propyl-1-methylpyrrolidinium ([Pyr 13]⁺), 1-butyl-1-methylpyrrolidinium ([Pyr₁₄]⁺), methyl-methylcarboxymethyl-pyrrolidinium ([MMMPyr]⁺), tetramethylammonium ([N1111]⁺), tetraethylammonium ([N2222]⁺), tributylmethylammonium ([N4441]⁺), diallyldimethyl ammonium ([DADMA]⁺), N—N-diethyl-N-methyl-N-(2-methyoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P_{1444]1}, diethylmethylisobutyl-phosphonium ([P₁₂₂₄]⁺), trihexdecylphosphonium ([P₆₆₆₁₀]⁺), trihexyltetradecylphosphonium ([P_{66614]}⁺), and combinations thereof. The anion may be selected from the group consisting of: hexafluoroarsenate, hexafluorophosphate, bis(fluorosulfonyl)imide (FSI), bis(trifluoromethanesulfonyl)imide (TFSI), tricyanomethanide, perchlorate, tetrafluoroborate, cyclo-difluoromethane-1,1-bis(sulfonyl)imide (DMSI), bis(perfloroethanesulfonyl)imide (BETI), bis(oxalate)boarate (BOB), difluoro(oxalato)borate (DFOB), bis(fluoromalonato)borate (BFMB), dihydrogen phosphate ion (H₂PO₄⁻), nitrate (NO₃⁻) , hydrogen sulfate (HSO₄⁻), and combinations thereof.

In one aspect, the fluidic carbon precursor may include a polymeric material and a solvent. The polymeric material may be selected from the group consisting of: aromatic resin, polycyclic aromatic hydrocarbon, polyacrylonitrile, polypyrrole, polyaniline, poly(methyl methacrylate), polyvinyl alcohol, and combinations thereof. The solvent may be selected from the group consisting of: tetrahydrofuran, dimethylformamide, dimethyl carbonate, ethylene carbonate, ethyl acetate, acetonitrile, acetone, toluene, propylene carbonate, diethyl carbonate, 1,2,2-tetrafluoroehtyl,2,2,3,3-tetrafluoropropyl, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including an electrode having hierarchical silicon columns and a carbonaceous network that at least partially fills spaces between the hierarchical silicon columns in accordance with various aspects or the present disclosure;

FIG. 2 is a schematic illustration of a hierarchical silicon column in accordance with various aspects of the present disclosure; and

FIG. 3 is a schematic illustration of a carbonaceous network in accordance with various aspects of the present disclosure

FIG. 4 is a flowchart illustrating an example method for forming an electrode having hierarchical silicon columns and a carbonaceous network that at least partially fills spaces between the hierarchical silicon columns in accordance with various aspects or the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including electrode having hierarchical silicon columns and a carbonaceous network that at least partially fills spaces between the hierarchical silicon columns Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

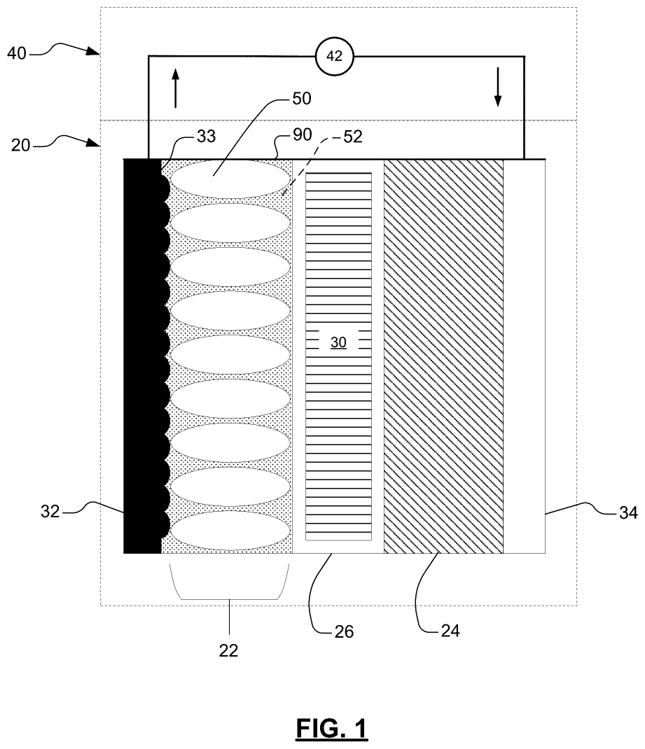

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising, for example, copper, stainless steel, nickel, iron, titanium, or any other appropriate electrically conductive material known to those of skill in the art. In certain variations, the first current collector 32 may be a coated foil including, for example, graphene or carbon coated stainless steel. In each instance, the first current collector 32 may have an average thickness greater than or equal to about 4 μm to less than or equal to about 30 μm, and in certain aspects, optionally about 14 μm.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising, for example, aluminum, or any other appropriate electrically conductive material known to those of skill in the art, and may have an average thickness greater than or equal to about 2 μm to less than or equal to about 30 μm.

In certain variations, the first current collector 32 and/or the second current collector 34 may include one or more roughen surfaces. For example, as illustrated, a surface 33 of the first current collector 32 that opposes the negative electrode 22 may have a roughen surface. The surface 33 may have a Rz, which is defined as the difference between the tallest “peak” and the deepest “valley”, of greater than or equal to about 0 μm to less than or equal to about 12 μm, optionally greater than or equal to about 1 μm to less than or equal to about 12 μm, and in certain aspects, optionally about 8 μm. The roughness may help to improve adhesion of the first current collector 32 to the negative electrode 22, and more particularly, copper to the hierarchical silicon columns 50.

The first current collector 32 and the second current collector 34 may be the same or different. In each instance, the first current collector 32 and the second current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel or series arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB (C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) layer and/or semi-solid-state electrolyte (e.g., gel) layer that functions as both an electrolyte and a separator. For example, the solid-state electrolyte layer and/or semi-solid-state electrolyte layer may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte layer and/or semi-solid-state electrolyte layer may include oxides (e.g., LiTi₂(PO₄)₃, LiGe₂(PO₄)₃, Li₇La₃Zr₂O₁₂, Li₃XLa_{2/3}-XTiO₃, Li₃PO₄), Li₃N, Li₄GeS₄, sulfide (e.g., Li₁₀GeP₂S₁₂, Li₂S-P₂S₅, Li₆PS₅Cl, Li₆PS₅Br, Li₆PS₅I), Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The positive electrode 24 (also referred to as the positive electroactive material layer) is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still further variations, the positive electrode 24 may be a composite electrode including a combination of positive electroactive materials. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may be optionally intermingled (e.g., slurry casted) with an electronically conductive material (i.e., conductive additive) that provide an electron conductive path and/or a polymeric binder material that improve the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 (also referred to as a negative electroactive material layer) is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have an average thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

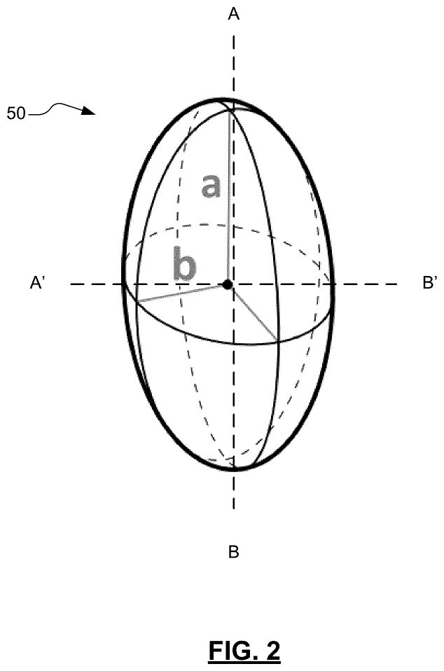

In certain variations, as illustrated, the negative electroactive material may include a plurality of hierarchical silicon columns 50 where a longest length A-B of each silicon column 50 is substantially perpendicular with a major axis of the current collector 32. As illustrated in FIG. 2, each of the hierarchical silicon columns 50 has a general oval shape where a first radius (a) (of the longer length A-B) is greater than a second radius (b) (of the shorter length A′-B′). In certain variations, the first radius (a) may be greater than or equal to about 0.5 μm to less than or equal to about 40 μm, and in certain aspects, optionally about 3.5 μm; and the second radius (b) may be greater than or equal to about 0.5 μm to less than or equal to about 40 μm, and in certain aspects, optionally about 3 μm. Each of the hierarchical silicon columns 50 may have an areal capacity greater than or equal to about 0.5 mAh/cm 2 to less than or equal to about 20 mAh/cm², and in certain aspects, optionally greater than or equal to about 1 mAh/cm 2 to less than or equal to about 10 mAh/cm².

Although not illustrated, in certain variations, the negative electrode 22 may also include a carbonaceous electroactive material (e.g., graphite) coated on or dispersed between the hierarchical silicon columns 50. For example, the negative electrode 22 may include greater than or equal to about 40 wt. % to less than or equal to about 99.99 wt. %, and in certain aspects, optionally greater than or equal to about 50 wt. % to less than or equal to about 99.99 wt. %, of the hierarchical silicon columns 50; and greater than or equal to about 0.01 wt. % to less than or equal to about 60 wt. %, and in certain aspects, optionally greater than or equal to about 0.01 wt. % to less than or equal to about 50 wt. %, of the carbonaceous electroactive material. In certain variations, the carbonaceous electroactive material may have an average size greater than or equal to about 0.05 μm to less than or equal to about 20 μm. The carbonaceous electrochemical materials may help to enhance the battery cycling performance, including capacity retention.

With renewed reference to FIG. 1, interstices or voids or spaces or pores or openings 52 may exist between the perpendicularly disposed silicon columns 50 and/or the optionally carbonaceous electroactive material. For example, a columnar silicon film optionally including a carbonaceous electroactive material may have a porosity greater than or equal to about 0 vol. % to less than or equal to about 40 vol. %, and in certain aspects, optionally greater than or equal to about 1 vol. % to less than or equal to about 20 vol. %. In certain variations, as illustrated, the negative electrode 22 may further include a carbonaceous network 90 that at least partially fills void spaces 52 between the hierarchical silicon columns 50 (and optionally the carbonaceous electroactive material). For example, the carbonaceous network 90 may occupy greater than or equal to about 60 vol. % to less than or equal to about 100 vol. % of the total void space 52 between the between the hierarchical silicon columns 50 (and optionally the carbonaceous electroactive material). The negative electrode 22 may include greater than or equal to about 0.01 wt. % to less than or equal to about 60 wt. %, and in certain aspects, optionally greater than or equal to about 0.01 wt. % to less than or equal to about 50 wt. %, of the carbonaceous network 90.

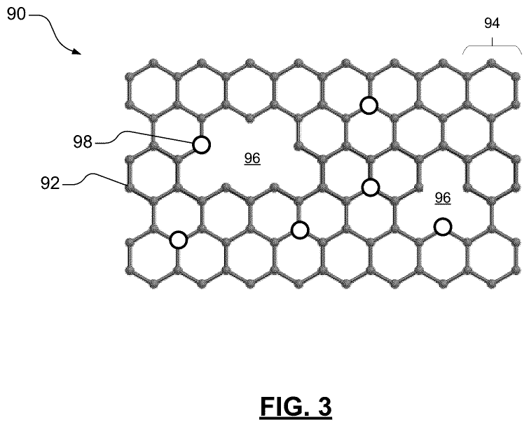

As illustrated in FIG. 3, the carbonaceous network 90 may include linked carbon atoms 92 forming, for example, a series or collection of hexagonal rings 94 that collectively define a plurality of pores 96. For example, the carbonaceous network may have a porosity greater than or equal to about 0 vol. % to less than or equal to about 80 vol. %. The porous configuration of the carbonaceous network 90 may improve lithium ion absorption in the negative electrode 22. The carbonaceous network 90 may help also to create favorable electronic conduction pathways between the hierarchical silicon columns 50, reducing the internal resistance and improving power capabilities of the negative electrode 22. For example, the carbonaceous network 90 may have an electrical conductivity greater than or equal to about 10⁻³ S/cm to less than or equal to about 10⁴ S/Cm at room temperature, and a BET surface area greater than or equal to about 5 m²/g to less than or equal to about 4,000 m²/g.

In certain variations, as illustrated, the carbonaceous network 90 may be doped with heteroatoms 98. For example, the negative electrode 22 may include greater than or equal to about 0 wt. % to less than or equal to about 50 wt. %, and in certain aspects, optionally greater than or equal to about 0 wt. % to less than or equal to about 30 wt. %, of the heteroatoms. The carbonaceous network 90 may include greater than or equal to about 0.5 wt. % to less than or equal to about 50 wt. % of the heteroatoms. The heteroatoms may include, for example, nitrogen, boron, oxygen, sulfur, phosphorus, silver, zinc, magnesium, iron, and/or the like. The presence of the one or more heteroatoms may help to further improve electronic mobility in the negative electrode 22.

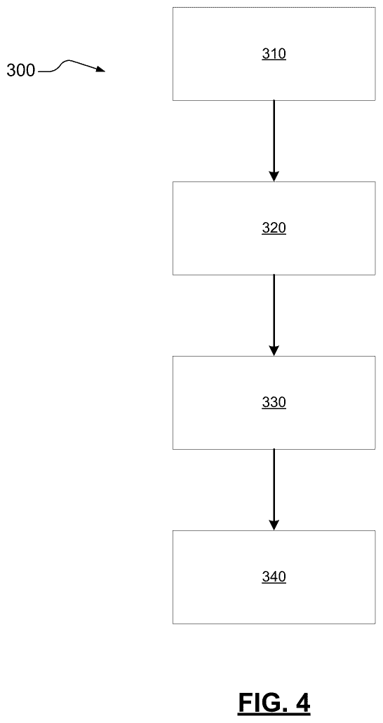

In various aspects, the present disclosure provides methods for forming columnar silicon anodes, like the negative electrode 22 illustrated in FIG. 2. For example, FIG. 4 illustrates an example method 300 for forming a negative electrode defined by a plurality of hierarchical silicon columns. The method 300 may include contacting 320 a columnar silicon anode film (or sheet-type columnar silicon anode) and a fluidic carbon precursor such that the fluidic carbon precursor impregnates (i.e., at least partially fills void spaces in) the columnar silicon anode film to form a precursor assembly. For example, the fluidic carbon precursor may flow into the void spaces of the columnar silicon anode film. In certain variations, the contacting 320 may include drop-wise processes, wet coating processes, and/or spraying processes.

The columnar silicon anode film may include a current collector (like the first current collector 32 illustrated in FIG. 1) and a plurality of hierarchical silicon columns disposed along one or more sides of the current collector, where a longest length A-B of each silicon column is substantially perpendicular with a major axis of the current collector. In certain variations, the columnar silicon anode film may also include a carbonaceous electroactive material coated on or dispersed between the hierarchical silicon columns. In each variation, the method 300 may also include preparing 310 the columnar silicon anode film. The columnar silicon anode film may be formed using a controlled physical vapor deposition (PVD) process. The controlled physical vapor deposition process may include three general steps: (1) vaporization of the silicon material from a strong source, (2) transportation of the disintegrated silicon material, and (3) nucleation and development to create the columnar silicon anode film.

In certain variations, the fluidic carbon precursor may be an ionic liquid including cations and anions. Example cations include Li(triglyme) ([Li(G₃)]⁺), Li(tetraglyme) ([Li(G₄)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyle-3-butylimidazolium ([DMBim]⁺), 1-alkyl-3-methylimidazolium ([Cnmim]⁺), 1-ally-3-methylimidazolium ([Amim]⁺), 1,3-diallylimidazolium ([Daim]⁺), 1-ally-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP_{13]}⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N1111]⁺), tetraethylammonium ([N2222]⁺), tributylmethylammonium ([N4441]⁺), diallyldimethylammonium ([DADMA]⁺), N—N-diethyl-N-methyl-N-(2-methyoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof. Example anions include hexafluoroarsenate, hexafluorophosphate, bis(fluorosulfonyl)imide (FSI), bis(trifluoromethanesulfonyl)imide (TFSI), tricyanomethanide, perchlorate, tetrafluoroborate, cyclo-difluoromethane-1,1-bis (sulfonyl)imide (DMSI), bis(perfloroethanesulfonyl)imide (BETI), bis(oxalate)boarate (BOB), difluoro(oxalato)borate (DFOB), bis(fluoromalonato)borate (BFMB), dihydrogen phosphate ion (H₂PO₄), nitrate (NO₃⁻), hydrogen sulfate (HSO₄), and combinations thereof. An example ionic liquid may include 1-butyl-3-methylimidazolium tricyanomethanide.

In other variations, the fluidic carbon precursor may include an aromatic resin and/or polycyclic aromatic hydrocarbon (PAH) in a solvent. In still other variations, the fluidic carbon precursor may be a polymer-containing precursor including, for example, polyacrylonitrile, polypyrrole, polyaniline, poly(methyl methacrylate), polyvinyl alcohol, and combinations thereof in the solvent. In each instance, the solvent may include, for example, tetrahydrofuran, dimethylformamide, dimethyl carbonate, ethylene carbonate, ethyl acetate, acetonitrile, acetone, toluene, propylene carbonate, diethyl carbonate, 1,2,2-tetrafluoroehtyl,2,2,3,3-tetrafluoropropyl, and combinations thereof. In each variation, the fluidic carbon precursor may include one or more heteroatoms.

With renewed reference to FIG. 4, in various aspects, the method 300 further includes heating 340 the precursor assembly to initiate in-situ carbonization of the fluidic carbon precursor. Carbonization of the fluidic carbon precursor creates a carbonaceous network (like the carbonaceous network 90 illustrated in FIG. 1) that at least partially fills void spaces between the hierarchical silicon columns (and optionally the carbonaceous electroactive material). In certain variations, the precursor assembly may be heated 340 to a first temperature greater than or equal to about 300° C. to less than or equal to about 1,000° C., and in certain aspects, optionally about 800° C. The first temperature may be held for a first time period greater than or equal to about 30 minutes to less than or equal to about 24 hours, and in certain aspects, optionally about 2 hours. In certain variations, the precursor assembly may be heated 340 to the first temperature using, for example, a tube furnace or muffle furnace where dinitrogen gas, argon, or other like gas is flowing.

In certain variations, for example, when the fluidic carbon precursor includes the solvent, the method 300 may also include a pre-drying process 330 to remove the solvent prior to the pyrolysis 340. The pre-drying process 330 may include heating the precursor assembly to a second temperature greater than or equal to about 30° C. to less than or equal to about 300° C. The second temperature may be held for a second time period greater than or equal to about 30 minutes to less than or equal to about 24 hours.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell that cycles lithium ions, the electrode comprising:
an electroactive material layer comprising:
a plurality of hierarchical silicon columns having interstices defined between hierarchical silicon columns of the plurality of hierarchical silicon columns; and
a carbonaceous network that at least partially fills the interstices, the carbonaceous network comprising linked carbon atoms that define a plurality of pores.

2. The electrode of claim 1, wherein the electroactive material layer has a total porosity greater than 0 vol. % to less than or equal to about 40 vol. %, and the carbonaceous network fills greater than or equal to about 60 vol. % to less than or equal to about 100 vol. % of the total porosity.

3. The electrode of claim 1, wherein the electroactive material layer further comprises a carbonaceous electroactive material.

4. The electrode of claim 1, wherein the electroactive material layer comprises greater than or equal to about 40 wt. % to less than or equal to about 99.99 wt. % of the hierarchical silicon columns, and greater than 0.01 wt. % to less than or equal to about 60 wt. % of the carbonaceous electroactive material.

5. The electrode of claim 1, wherein the carbonaceous network has a porosity greater than 0 vol. % to less than or equal to about 80 vol. %.

6. The electrode of claim 1, wherein the carbonaceous network further comprises greater than 0 wt. % to less than or equal to about 50 wt. % of a heteroatom.

7. The electrode of claim 6, wherein the heteroatom is selected from the group consisting of: nitrogen, boron, oxygen, sulfur, phosphorus, silver, zinc, magnesium, iron, and combinations thereof.

8. The electrode of claim 1, wherein the electrode further comprises:
a current collector disposed on or adjacent to the electroactive material layer, wherein a longest dimension of each hierarchical silicon column is perpendicular to a major axis of the current collector.

9. The electrode of claim 1, wherein a surface of the current collector facing the electroactive material layer is a roughen surface having a Rz greater than 0 μm to less than or equal to about 12 μm.

10. The electrode of claim 1, wherein the hierarchical silicon columns have an areal capacity greater than or equal to about 0.5 mAh/cm 2 to less than or equal to about 20 mAh/cm 2, and the carbonaceous network has an electrical conductivity greater than or equal to about 10⁻³ S/cm to less than or equal to about 10⁴ S/Cm at 22° C. and a BET surface area greater than or equal to about 5 m²/g to less than or equal to about 4,000 m²/g.

11. An electrochemical cell that cycles lithium ions, wherein the electrochemical cell comprises:
a first electrode comprising a first current collector and a first electroactive material layer disposed on or near the first current collector;
a second electrode comprising a second current collector and a second electroactive material layer disposed on or near the second current collector, the second electroactive material layer comprising:
a plurality of hierarchical silicon columns, each of the hierarchical silicon columns having a longest dimension perpendicular to a major axis of the second current collector; and
a carbonaceous network that at least partially fills interstices defined between hierarchical silicon columns of the plurality of hierarchical silicon columns, the carbonaceous network comprising linked carbon atoms that define a plurality of pores; and
a separating layer disposed between the first electroactive material layer and the second electroactive material layer.

12. The electrochemical cell of claim 11, wherein the separating layer is a solid-state electrolyte.

13. The electrochemical cell of claim 11, wherein the separating layer comprises a liquid electrolyte.

14. The electrochemical cell of claim 11, wherein the second electroactive material layer further comprises a carbonaceous electroactive material, the second electroactive material layer comprising:
greater than or equal to about 40 wt. % to less than or equal to about 99.99 wt. % of the hierarchical silicon columns;
greater than 0.01 wt. % to less than or equal to about 60 wt. % of the carbonaceous electroactive material; and
greater than or equal to about 0.01 wt. % to less than or equal to about 60 wt. % of the carbonaceous network.

15. The electrochemical cell of claim 11, wherein the second electroactive material layer has a total porosity greater than 0 vol. % to less than or equal to about 40 vol. %, and the carbonaceous network fills greater than or equal to about 60 vol. % to less than or equal to about 100 vol. % of the total porosity.

16. The electrochemical cell of claim 11, wherein the carbonaceous network further comprises greater than 0 wt. % to less than or equal to about 50 wt. % of a heteroatom selected from the group consisting of: nitrogen, boron, oxygen, sulfur, phosphorus, silver, zinc, magnesium, iron, and combinations thereof.

17. The electrochemical cell of claim 11, wherein a surface of the second current collector facing the second electroactive material layer is a roughen surface having a Rz greater than 0 μm to less than or equal to about 12 μm.

18. A method for forming an electrode, the method comprising:
contacting a columnar silicon anode film and a fluidic carbon precursor so the fluidic carbon precursor impregnates the columnar silicon anode film and forms a precursor assembly, wherein the columnar silicon anode film is defined by a plurality of hierarchical silicon columns defining interstices therebetween; and
heating the precursor assembly to a temperature greater than or equal to about 300° C. to less than or equal to about 1,000° C. to carbonize the fluidic carbon precursor and form a carbonaceous network that at least partially fills the interstices between the hierarchical silicon columns.

19. The method of claim 18, wherein the fluidic carbon precursor is an ionic liquid comprising:
a cation selected from the group consisting of: Li(triglyme) ([Li(G₃)]⁺), Li(tetraglyme) ([Li(G₄)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyle-3-butylimidazolium ([DMBim]⁺), 1-alkyl-3-methylimidazolium ([Cnmim]⁺), 1-ally-3-methylimidazolium ([Amim]⁺), 1,3-diallylimidazolium ([Daim]⁺), 1-ally-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP_{13]}⁺), 1-butyl-1-methylpiperidinium ([PP)₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N1111]⁺), tetraethylammonium ([N2222]⁺), tributylmethylammonium ([N4441]⁺), diallyldimethylammonium ([DADMA]⁺), N—N-diethyl-N-methyl-N-(2-methyoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]+), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), tricyanomethanide, perchlorate, tetrafluoroborate, cyclo-difluoromethane-1,1-bis (sulfonyl)imide (DMSI), bis(perfloroethanesulfonyl)imide (BETI), bis(oxalate)boarate (BOB), difluoro(oxalato)borate (DFOB), bis(fluoromalonato)borate (BFMB), dihydrogen phosphate ion (H₂PO₄), nitrate (NO₃⁻), hydrogen sulfate (HSO₄⁻), and combinations thereof.

20. The method of claim 18, wherein the fluidic carbon precursor comprises a polymeric material and a solvent, wherein the polymeric material is selected from the group consisting of: aromatic resin, polycyclic aromatic hydrocarbon, polyacrylonitrile, polypyrrole, polyaniline, poly(methyl methacrylate), polyvinyl alcohol, and combinations thereof and the solvent is selected from the group consisting of: tetrahydrofuran, dimethylformamide, dimethyl carbonate, ethylene carbonate, ethyl acetate, acetonitrile, acetone, toluene, propylene carbonate, diethyl carbonate, 1,2,2-tetrafluoroehtyl,2,2,3,3-tetrafluoropropyl, and combinations thereof.
